(19) United States
(12) Patent Application Publication
(10) Pub. No.: US 2008/0218441 A1
(43) Pub. Date: Sep. 11, 2008

(54) PLASMA DISPLAY PANEL

(76) Inventors: Tae-Seung Cho, Suwon-si (KR); Won-Ju Yi, Suwon-si (KR); Kyoung-Doo Kang, Suwon-si (KR); Young-Do Choi, Suwon-si (KR); Jae-Ik Kwon, Suwon-si (KR); Seok-Gyun Woo, Suwon-si (KR); Yong-Shik Hwang, Suwon-si (KR); Byoung-Min Chun, Suwon-si (KR); Jong-Woo Choi, Suwon-si (KR)

Correspondence Address: CHRISTIE, PARKER & HALE, LLP, PO BOX 7068, PASADENA, CA, 91109-7068, US

(21) Appl. No.: 12/041,588

(22) Filed: Mar. 3, 2008

(30) Foreign Application Priority Data
Mar. 5, 2007 (KR) 10-2007-0021553

(51) Int. Cl. G09G 3/28

(52) U.S. Cl. 345/60

(57) ABSTRACT

A plasma display panel is provided in discharge spaces in which phosphor layers are disposed between first and second electrodes which are spaced apart from each other. The cross-sectional area of each discharge space in two regions where the first and second electrodes are respectively arranged has a different structure.

### CROSS-REFERENCE TO RELATED PATENT APPLICATION

This application claims priority to and the benefit of Korean Patent Application No. 10-2007-0021553, filed on Mar. 5, 2007, in the Korean Intellectual Property Office, the entire content of which is incorporated herein by reference.

### BACKGROUND OF THE INVENTION

1. Field of the Invention

The present invention relates to a plasma display panel (PDP), and more particularly, to a PDP having electrodes formed at sidewalls of discharge spaces.

2. Description of the Related Art

Typical alternating current (AC) PDPs include an upper plate that displays an image to users, and a lower plate that is coupled to, and parallel to, the upper plate. The front substrate of the upper plate includes sustain electrode pairs arranged thereon. The rear substrate of the lower plate includes address electrodes arranged on a surface facing the surface of the front substrate on which the sustain electrode pairs are arranged. The direction of the address electrodes intersects the direction of the sustain electrode pairs.

A first dielectric layer and a second dielectric layer are respectively formed on the surface of the front substrate, on which the sustain electrode pairs are arranged, and on the surface of the rear substrate, on which the address electrodes are arranged, so that the sustain electrode pairs and the address electrodes are buried. A protection layer generally formed of magnesium oxide (MgO) is arranged on a rear surface of the first dielectric layer. Barrier ribs, for maintaining a discharge distance between the opposing substrates and preventing optical cross-talk between discharge cells, are arranged on the front surface of the second dielectric layer.

Red, green, and blue phosphors are appropriately coated on sidewalls of the barrier ribs and on the front surface of the second dielectric layer.

Each of the sustain electrode pairs includes a transparent electrode and a bus electrode. The transparent electrode is formed of a conductive material capable of generating a discharge and is transparent so as to allow light emitted from the phosphors to propagate toward the front substrate. The transparent material may be indium tin oxide (ITO) or the like. The bus electrode may be typically a metal electrode having high electric conductivity, and is black-colored so as to improve a bright room contrast.

In conventional surface type PDPs, visible light is emitted from phosphor layers of discharge spaces and transmits through an upper substrate when a discharge occurs. However, the upper substrate has a visible transmittance of about 60% due to various constituents formed thereon.

Furthermore, in conventional surface type PDPs, electrodes are formed on upper sides of discharge spaces, i.e., inner sidewalls of the upper substrate through which the visible light transmits, and these electrodes generate the discharge in the inner sidewalls, which reduces luminous efficiency.

### SUMMARY OF THE INVENTION

The present invention provides a PDP where phosphor layers are disposed between electrodes spaced apart from each other and around discharge spaces and where the electrodes have different structures around the discharge spaces, thereby increasing brightness of the PDP.

According to an aspect of the present invention, there is provided a PDP having a first substrate and a second substrate spaced apart from the first substrate and facing the first substrate. Barrier ribs are disposed between the first substrate and the second substrate and configure a plurality of discharge spaces. First electrodes are arranged in the barrier ribs and extend in a first direction substantially parallel with the first substrate and the second substrate and between the first substrate and the second substrate. Second electrodes in the barrier ribs are spaced apart from the first electrodes and extend in a second direction substantially parallel with the first substrate and the second substrate. An intermediate layer is disposed in the barrier ribs between the first electrodes and the second electrodes. A first phosphor layer is arranged on sidewalls of the discharge spaces at the intermediate layer.

The cross-sectional area of the discharge spaces at the intermediate layer may be greater than the cross-sectional area of the discharge spaces proximal to the second electrodes.

The cross-sectional area of the discharge spaces contacting the first phosphor layers may be greater than the cross-sectional area of the discharge spaces proximal to the second electrodes.

The first phosphor layers may be inclined linearly or in a concave parabolic shape in a direction from the first electrodes to the second electrodes.

The first phosphor layers may be inclined at a predetermined angle and face the first substrate.

The first electrodes and/or the second electrodes may surround at least a portion of each of the discharge spaces.

The perimeter of the second electrodes surrounding the discharge spaces may be shorter than that of the first electrodes.

The cross-sectional area of each of the discharge spaces surrounded by the second electrodes may be smaller than that of each of the discharge spaces surrounded by the first electrodes.

The PDP may further include grooves having a specific depth and formed on the first substrate facing each of the discharge spaces; and a second phosphor layer arranged in the grooves.

The first electrodes and/or the second electrodes may be buried in the barrier rib.

The barrier ribs may include a first electrode layer where the first electrodes are arranged, a second electrode layer where the second electrodes are arranged, and an intermediate layer disposed between the first electrode layer and the second electrode layer.

A first electrode sheet where the first electrodes may be arranged is formed on the first electrode layer. A second electrode sheet where the second electrodes are arranged may be formed on the second electrode layer. The intermediate layer may be an intermediate sheet disposed between the first electrode sheet and the second electrode sheet.

The intermediate sheet and the second electrode sheet may be formed of one sheet.

According to another aspect of the present invention, there is provided a PDP having a first substrate and a second substrate spaced apart from the first substrate and facing the first substrate. Barrier ribs are disposed between the first substrate and the second substrate and configure a plurality of discharge spaces. First electrodes are arranged in the barrier rib and extend in a first direction substantially parallel to the first substrate and the second substrate between the first substrate and the second substrate. Second electrodes are arranged on the second substrate facing the first substrate and extend so as to cross the first electrodes. An intermediate layer is disposed in the barrier rib between the first electrodes and the second electrodes. A first phosphor layer is arranged on sidewalls of the discharge spaces contacting the intermediate layer, wherein the cross-sectional area of the discharge spaces at the intermediate layer is larger than the cross-sectional area of the discharge spaces proximal to the second electrodes.

The PDP may further include a dielectric layer disposed on the second substrate so as to bury the second electrodes, wherein the first phosphor layer is arranged on sidewalls of the discharge spaces contacting the intermediate layer and on the dielectric layer in the discharge spaces.

### BRIEF DESCRIPTION OF THE DRAWINGS

FIG. 1 is a partially exploded perspective view of a PDP where first phosphor layers are disposed on sidewalls of discharge spaces contacting an intermediate layer disposed between a first electrode layer and a second electrode layer according to an embodiment of the present invention.

FIG. 2 is a cross-sectional view taken along the line II-II of FIG. 1.

FIG. 3 schematically illustrates arrangements of electrodes and discharge cells of the PDP illustrated in FIG. 1.

FIG. 4 is a partially exploded perspective view of a PDP where surfaces facing discharges spaces contacting an intermediate layer are inclined toward a first substrate since discharge spaces in a second electrode layer are smaller than those in a first electrode layer according to another embodiment of the present invention.

FIG. 5 is a cross-sectional view taken along the line V-V of FIG. 4.

FIG. 6 schematically illustrates arrangements of electrodes and discharge cells of the PDP illustrated in FIG. 4.

FIG. 7 is a partially exploded perspective view of a PDP where second electrodes are arranged on a second substrate according to another embodiment of the present invention.

FIG. 8 is a cross-sectional view taken along the line VIII-VIII of FIG. 7.

FIG. 9 is a cross-sectional view taken along the line V-V of FIG. 4 according to another embodiment where the first phosphor layers are inclined in a concave parabolic shape in a direction from the first electrodes to the second electrodes.

FIG. 10 is a cross-sectional view taken along the line VIII-VIII of FIG. 7 according to another embodiment where the first phosphor layers are inclined in a concave parabolic shape in a direction from the first electrodes to the second electrodes.

FIG. 11 is a cross-sectional view showing the shape of the discharge spaces of FIG. 4 and FIG. 7 according to another embodiment where the discharge spaces have oval cross-sections.

### DETAILED DESCRIPTION

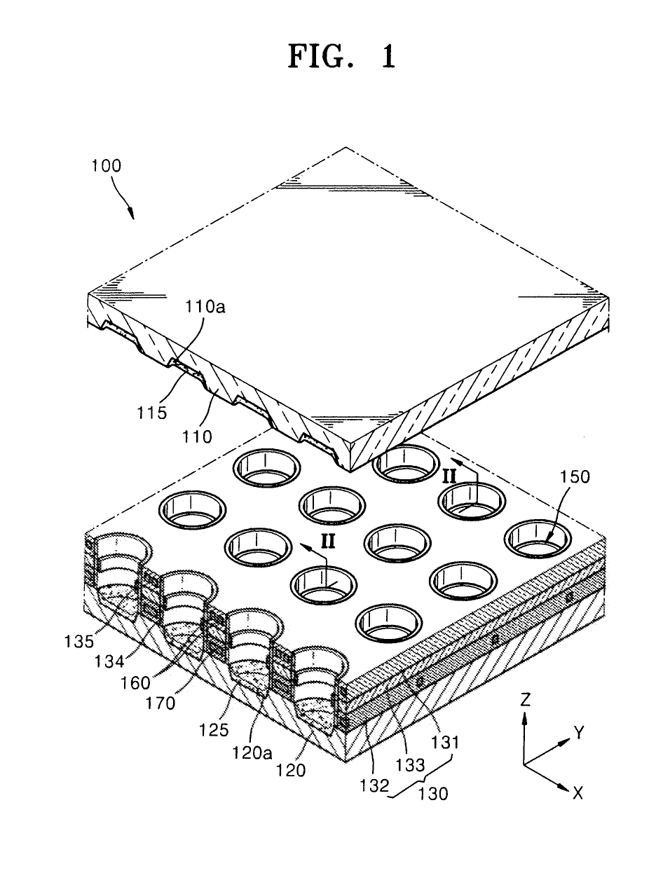

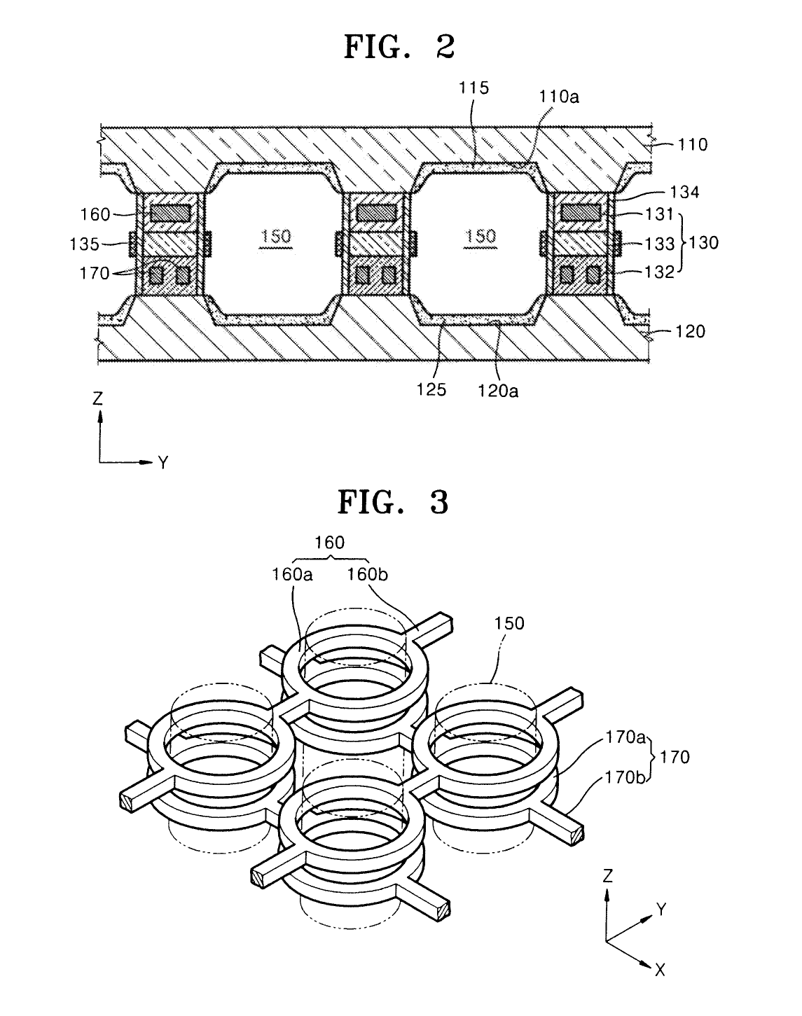

FIG. 1 is a partially exploded perspective view of a PDP 100 where first phosphor layers 135 are disposed on sidewalls of discharge spaces 150 facing an intermediate layer 133 disposed between a first electrode layer 131 and a second electrode layer 132 according to an embodiment of the present invention. FIG. 2 is a cross-sectional view taken along the line II-II of FIG. 1. FIG. 3 schematically illustrates arrangements of electrodes and discharge cells of the PDP 100 illustrated in FIG. 1.

Referring to FIGS. 1, 2, and 3, the PDP 100 includes a first substrate 110, a second substrate 120, barrier ribs 130, the first phosphor layers 135, second phosphor layers 115, third phosphor layers 125, first electrodes 160, second electrodes 170, and protective layers 134.

The first substrate 110 and the second substrate 120 are spaced apart from each other by the barrier ribs 130 and face each other. The barrier rib 130 is disposed between the first substrate 110 and the second substrate 120 and configures a plurality of discharge spaces 150. The first electrodes 160 are arranged in the first electrode layer 131 and extend in a Y-direction between the first substrate 110 and the second substrate 120. The second electrodes 170 are arranged in the second electrode layer 132 and spaced apart from the first electrodes 160 by the intermediate layer 133 and extend in an X-direction between the first substrate 110 and the second substrate 120.

The intermediate layer 133 is disposed between two regions where the first electrodes 160 and the second electrodes 170 are respectively arranged. In more detail, the barrier rib 130 includes the first electrode layer 131, the second electrode layer 132, and the intermediate layer 133 disposed between the first electrode layer 131 and the second electrode layer 132. The first phosphor layers 135 are arranged on sidewalls of the discharge spaces 150 at a level of the intermediate layer 133.

The discharge spaces 150 can have circular or oval cross-sections, but are not necessarily restricted thereto, and can have polygonal cross-sectional shapes such as triangular, tetragonal, octagonal, etc. The discharge spaces 150 of the barrier rib 130 can have a waffle or delta configuration.

The protective layers 134 are arranged on sides of the discharge spaces 150 partitioned by the barrier rib 130. The protective layers 134 prevent the barrier rib 130 formed of a dielectric substance and the first and second electrodes 160, 170 from being damaged due to sputtering of plasma particles, discharge secondary electrons, and reduce a discharge voltage. The protective layers 134 are formed of MgO having a predetermined thickness and are arranged on the sidewalls of the discharge spaces 150.

The first electrodes 160 and the second electrodes 170 extend such that their respective directions cross each other and, more particularly, extend perpendicular to each other. The first electrodes 160 and the second electrodes 170 extend in planes parallel to each other. The first electrodes 160 and/or the second electrodes 170 are disposed so as to surround each of the discharge spaces 150 by respective portions 160a, 170a. Adjacent protions 160a interconnect by segments 160b. Adjacent portions 170a interconnect by segments 170b. The first electrodes 160 and the second electrodes 170 can be buried in the barrier rib 130 according to the type of the discharge spaces 150.

First grooves 110a having a specific depth can be formed on the first substrate 110 in each of the discharge spaces 150. A respective second phosphor layer 115 can be arranged in each of the first grooves 110a.

Second grooves 120a having a specific depth can be formed on the second substrate 120 The first grooves 110a can be discontinuously formed in each of the discharge spaces 150. A respective third phosphor layer 125 can be arranged in each of the second grooves 120a.

The second phosphor layers 115 and the third phosphor layers 125 are disposed on the first substrate 110 and the second substrate 120, respectively, so that the PDP 100 of the present embodiment can increase brightness and luminous efficiency.

A discharge occurs between the first substrate 110 and the second substrate 120, which generates efficient plasma at the level of the intermediate layer 133 disposed between the first substrate 110 and the second substrate 120. However, since the efficient plasma is far away from the second phosphor layers 115 and the third phosphor layers 125 disposed on the first substrate 110 and the second substrate 120, respectively, a considerable amount of ultraviolet rays are not emitted but instead disappear.

Therefore, the first phosphor layers 135 are arranged at the intermediate layer 133 between the first substrate 110 and the second substrate 120 so as to make it easier for ultraviolet rays generated from the efficient plasma to reach the first phosphor layers 135. Therefore, a larger amount of the ultraviolet rays generated from the efficient plasma can be emitted, which increases brightness and luminous efficiency.

A plasma column (not shown) can be formed in each discharge space 150 when the discharge occurs. Each discharge space 150 can have a diameter less than 100 μm in order to have the most effective plasma column. However, such a small diameter can cause difficulties in the process of manufacturing a PDP.

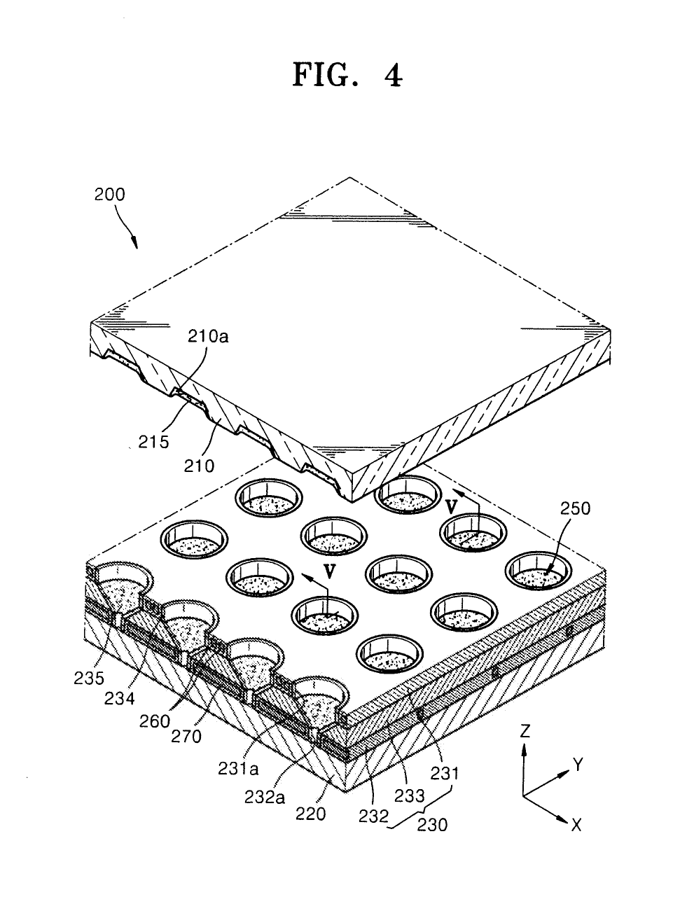

In order to address such manufacturing problems, a diameter of each discharge space where second electrodes are formed is reduced so as to form the most effective plasma, and a diameter of each discharge space where first electrodes are formed corresponds to the size of a pixel for the PDPs 200, 300 illustrated in FIGS. 4 through 8. In this case, phosphor layers arranged at an intermediate layer face a first substrate on which the image is displayed, so that the PDPs 200, 300 can provide increased brightness greater than that of the PDP 100 illustrated in FIGS. 1 through 3.

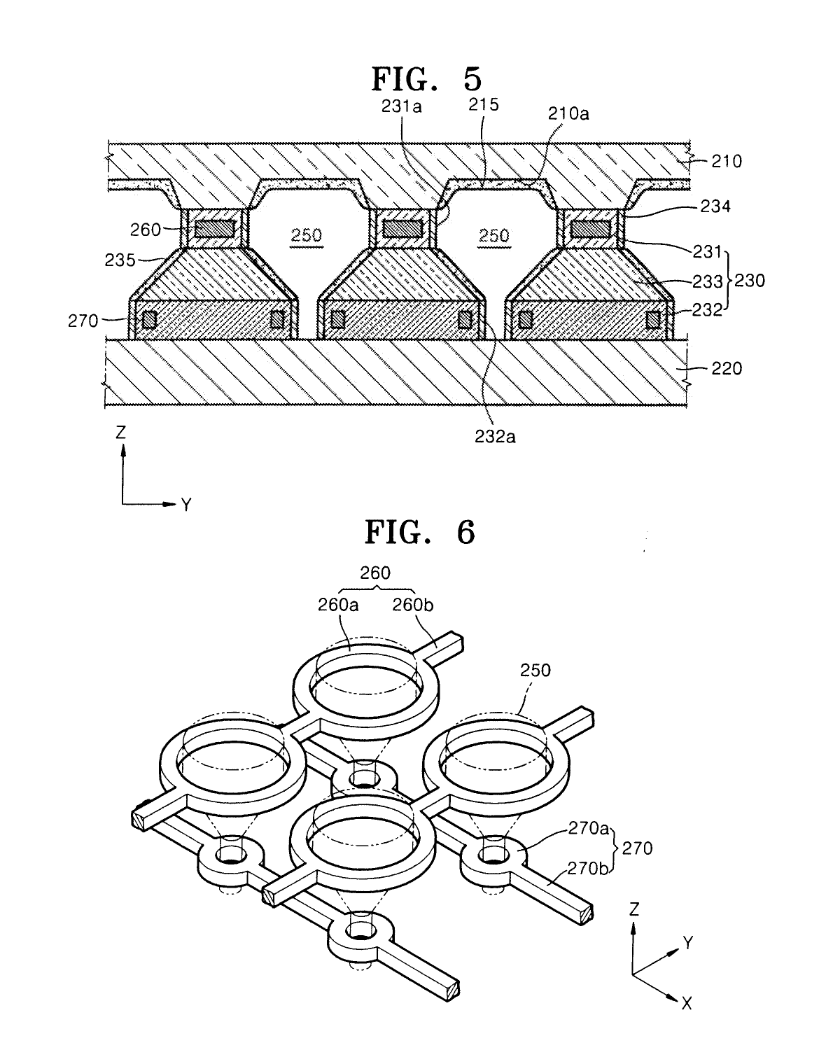

According to another embodiment of the present invention, FIG. 4 shows a partially exploded perspective view of the PDP 200 where surfaces facing discharge spaces contacting an intermediate layer 233 are inclined toward a first substrate 210 since discharge spaces in a second electrode layer 232 are smaller than those in a first electrode layer 231. FIG. 5 is a cross-sectional view taken along the line V-V of FIG. 4. FIG. 6 schematically illustrates arrangements of electrodes and discharge cells of the PDP illustrated in FIG. 4.

Referring to FIGS. 4, 5, and 6, the PDP 200 includes the first substrate 210, a second substrate 220, barrier ribs 230, first electrodes 260, second electrodes 270, first phosphor layers 235, second phosphor layers 215, and protective layers 234. The intermediate layer 233 disposed between two regions where the first electrodes 260 and the second electrodes 270 are respectively arranged is inclined toward the first substrate 210 on which an image is displayed.

The first substrate 210 and the second substrate 220 are spaced apart from each other by the barrier rib 230 and face each other. The barrier rib 230 is disposed between the first substrate 210 and the second substrate 220 and configures a plurality of discharge spaces 250. The first electrodes 260 are arranged in the first electrode layer 231 and extend in a Y-direction between the first substrate 210 and the second substrate 220. The second electrodes 270 are arranged in the second electrode layer 232 and spaced apart from the first electrodes 260 by the intermediate layer 233 and extend in an X-direction between the first substrate 210 and the second substrate 220.

The intermediate layer 233 is disposed between two regions where the first electrodes 260 and the second electrodes 270 are respectively arranged. In more detail, the barrier rib 230 includes the first electrode layer 231, the second electrode layer 232, and the intermediate layer 233 disposed between the first electrode layer 231 and the second electrode layer 232. First phosphor layers 235 are arranged on sidewalls of discharge spaces 250 contacting the intermediate layer 233.

Each of the first electrode layer 231 and the second electrode layer 232 can be formed of a sheet in which the first electrodes 260 and the second electrodes 270 are disposed, respectively. In more detail, the first electrode layer 231 can be a first electrode sheet where the first electrodes 260 are disposed, and the second electrode layer 232 can be a second electrode sheet where the second electrodes 270 are disposed.

The intermediate layer 233 can be an intermediate sheet disposed between the first electrode sheet and the second electrode sheet. The intermediate sheet can be integrally formed with the second electrode sheet.

The diameter of each discharge space 250 contacting the intermediate layer 233 is smaller closer to the second electrodes 270 than the diameter of each discharge space 250 closer to the first electrodes 260.

In more detail, each discharge space 250 at the second electrode layer 232 has a smaller cross-sectional area than at the first electrode layer 231. Therefore, the diameter of each discharge space 250 contacting the intermediate layer 233 tapers from a larger diameter at the first electrode layer 231 to a smaller diameter at the second electrode layer 232.

Each discharge space 250 of the PDP 200 can have a diameter less than 100 μm in order to form the most effective plasma column. Therefore, the diameter of each discharge space 250 contacting the first electrode layer 231 remains unchanged, whereas the diameter of each discharge space 250 contacting the second electrode layer 232 is reduced. In more detail, the diameter of each discharge space 250 contacting the second electrode layer 232 in which the second electrodes 270 are arranged is reduced so as to form the most effective plasma column, whereas the diameter of each discharge space 250 contacting the first electrode layer 231 in which the first electrodes 260 are arranged remains unchanged so as to correspond to the size of each pixel for the image displayed on the first substrate 210.

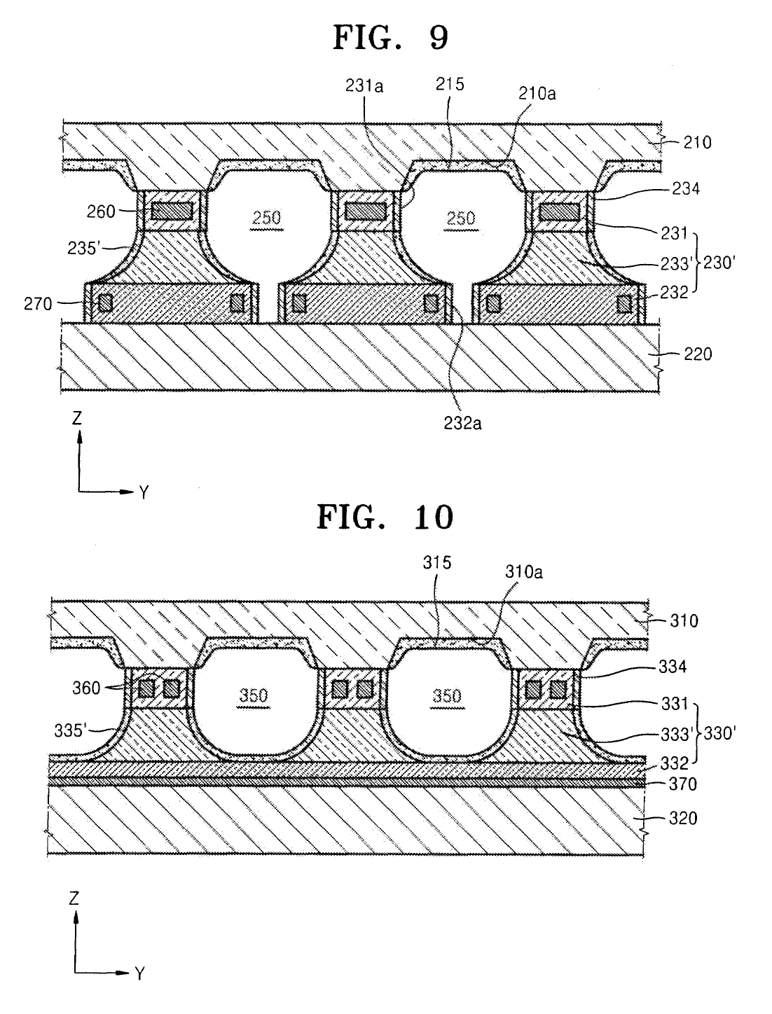

Accordingly, the intermediate layer 233 is inclined at a predetermined angle toward the first substrate 210 on which the image is displayed. Each discharge space 250 contacting the intermediate layer 233 and/or the first phosphor layers 235 can have a linear conical shape in a direction from the first electrode layer 231 to the second electrode layer 232. Also, the first phosphor layers 235′ may have a concave parabolic shape in a direction from the first electrode layer 231 to the second electrode layer 232 as shown in FIG. 9, and, accordingly, barrier rib 230′ would have a similarly shaped intermediate layer 233′.

Therefore, the first phosphor layers 235 formed on each discharge space 250 contacting the intermediate layer 233 face the first substrate 210 on which the image is displayed, so that the PDP 200 can have increased brightness greater than that of the PDP 100 illustrated in FIGS. 1 through 3.

The discharge spaces 250 can have circular or oval cross-sections, but are not necessarily limited thereto, and can have polygonal cross-sectional shapes such as triangular, tetragonal, octagonal, etc. The discharge spaces 250 of the barrier rib 230 can have a waffle or delta configuration. The discharge spaces 450 having oval cross-sections are shown FIG. 11.

The protective layers 234 are arranged on sides of the discharge spaces 250 partitioned by the barrier rib 230. The protective layers 234 prevent the barrier rib 230 formed of a dielectric substance and the first and second electrodes 260, 270 from being damaged due to sputtering of plasma particles, discharge secondary electrons, and reduce a discharge voltage. The protective layers 234 are formed of MgO having a predetermined thickness and are arranged on the sidewalls of the discharge spaces 250.

The protective layers 234 include first protective layers 231a and second protective layers 232a. The first protective layers 231a are disposed within the discharge spaces 250 contacting the first electrode layers 231. The second protective layers 232a are disposed within the discharge spaces 250 contacting the second electrode layers 232. The protective layers 234 shown in FIGS. 4 and 5 are not formed within the discharge spaces 250 contacting the intermediate layer 233. However, the protective layers 234 may alternatively be formed within the discharge spaces 250 contacting the intermediate layer 233.

The first electrodes 260 and the second electrodes 270 extend such that their directions cross each other and, more particularly, extend perpendicular to each other. The first electrodes 260 and the second electrodes 270 extend in planes parallel to each other. The first electrodes 260 and/or the second electrodes 270 are disposed so as to surround each discharge space 250 by respective portions 260a, 270a. Adjacent portions 260a interconnect by segments 260b. Adjacent portions 270a interconnect by segments 270b. The first electrodes 260 and the second electrodes 270 can be buried in the barrier rib 230 according to the type of the discharge spaces 250.

The PDP 200 according to the present embodiment is not limited to a two-electrode structure. That is, the PDP 200 may not only have the two-electrode structure as shown in FIGS. 4 through 6, but may also have a three-electrode structure. For example, the first and second electrodes 260, 270 extend in a direction between the first and second electrodes 260, 270, and third electrodes (not shown) would extend such that their direction crosses the first and second electrodes 260, 270 and are spaced apart from the first and second electrodes 260, 270 by a predetermined gap between the first substrate 210 to the second substrate 220. The third electrodes can be disposed between the first and second electrodes 260, 270, i.e., in the intermediate layer 233.

Grooves 210a having a specific depth can be formed on the first substrate 210 in each discharge space 250. Respective second phosphor layers 215 can be arranged in the grooves 210a.

The first and second phosphor layers 235, 215 have a component generating visible rays by ultraviolet rays. That is, a phosphor layer formed in a red light-emitting discharge cell has a phosphor such as Y(V,P)0₄:Eu, a phosphor layer formed in a green light-emitting discharge cell has a phosphor such as Zn₂SiO₄:Mn, YBO₃:Tb, and a phosphor layer formed in a blue light-emitting-discharge cell has a phosphor such as BAM:Eu.

A discharge gas such as Ne, Xe, or a mixture thereof is filled into the discharge cells formed by the discharge spaces 250.

The first substrate 210, which can be considered a front substrate, and the second substrate 220, which can be considered a rear substrate, are formed of glass having a high visible transmittance. However, the first substrate 210 and/or the second substrate 220 can be colored to improve a bright room contrast by reducing reflective brightness.

In the present embodiment, visible rays generated in the discharge spaces 250 can pass through the first substrate 210. Sustain electrodes, dielectric layers, and protective layers that are formed on a front substrate of a conventional PDP are not formed on the first substrate 210, and thus the transmission ratio of visible rays can be remarkably increased. Therefore, when the PDP 200 of the present embodiment displays an image having the conventional brightness, the first electrodes 260 and the second electrodes 270 can be driven at a relatively low voltage.

The barrier rib 230 is disposed between the first substrate 210 and the second substrate 220, configures the discharge spaces 250, and prevents optical and electrical cross-talk between adjacent discharge spaces 250. In the present embodiment, the barrier rib 230 configures the discharge spaces 250 having circular cross-sections, but the present invention is not limited thereto. The discharge spaces 250 can have other cross-sectional shapes including oval and polygonal cross-sections.

In more detail, the barrier rib 230 can have a variety of patterns so as to configure the discharge spaces 250. For example, the barrier rib 230 may configure the discharge spaces 250 having polygonal cross-sections, such as triangular, tetragonal, or pentagonal cross-sections, or oval cross-sections. The discharge spaces 250 of the barrier rib 230 can have a waffle or delta configuration.

As illustrated in FIG. 6, the first electrodes 260 and the second electrodes 270 comprise pairs and generate the discharge in the discharge spaces 250. Each of the first electrodes 260 surrounds the discharge spaces 250 extending in a Y direction. Each of the second electrodes 270 surrounds the discharge spaces 250 extending in an X direction. The second electrodes 270 are spaced apart from the first electrodes 260 in a direction perpendicular to the surface of the first substrate 210 (in a Z direction) in the barrier rib 230.

The first electrodes 260 and the second electrodes 270 surround at least a portion of each of the discharge spaces 250. The first electrodes 260 and the second electrodes 270 can partially or wholly surround each of the discharge spaces 250. The first electrodes 260 and the second electrodes 270 have circular loop shapes but the present invention is not limited thereto. The first electrodes 260 and the second electrodes 270 can have various shapes including rectangular loop shapes, and may have substantially the same shape as the cross-sections of the discharge spaces 250.

Since the first and second electrodes 260, 270 are not disposed to directly reduce a transmittance ratio of visible rays, they can be formed of a conductive metal such as Al, Cu, etc. Therefore, a voltage drop is small in a lengthwise direction of the first and second electrodes 260, 270, thereby delivering a stable signal.

The first and second electrodes 260, 270 are buried in the barrier rib 230. Therefore, the barrier rib 230 may be formed of a dielectric substance to prevent direct conduction between the adjacent first and second electrodes 260, 270, to prevent the first and second electrodes 260, 270 from being damaged due to collisions between positive ions or electrons and the first and second electrodes 260, 270 which induce charges and accumulate wall charges.

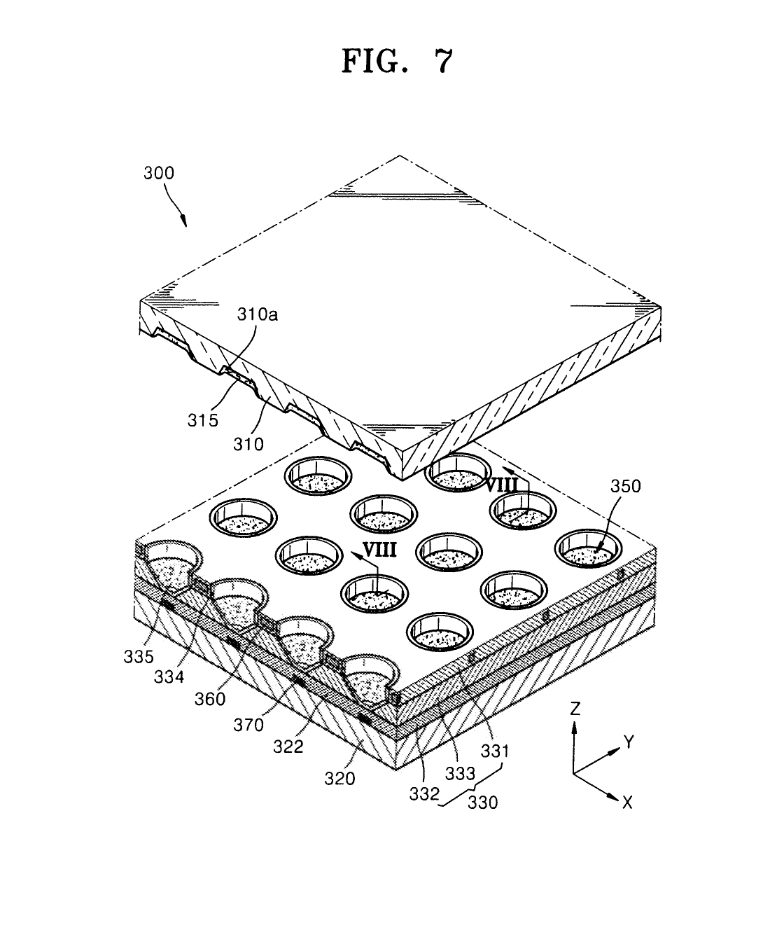

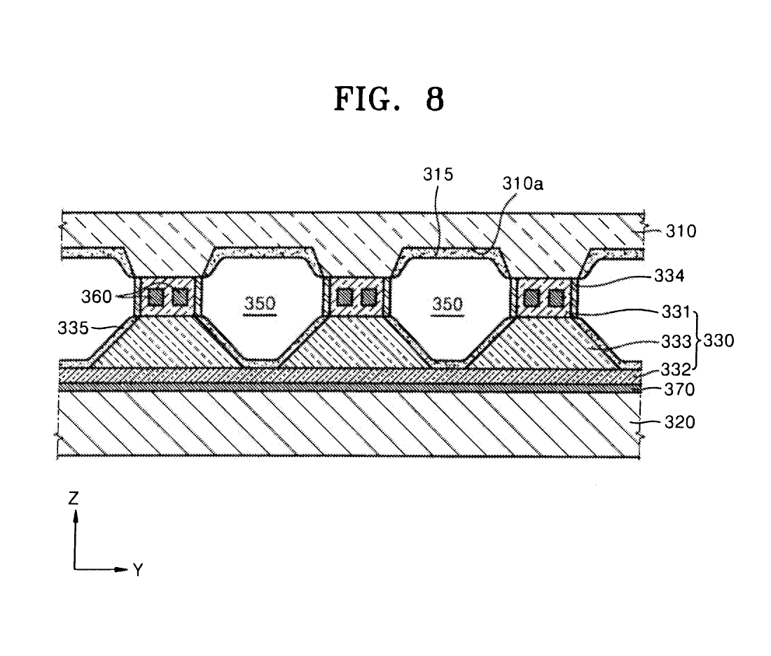

FIG. 7 is a partially exploded perspective view of a PDP 300 where second electrodes 370 are arranged on a second substrate 320 according to another embodiment of the present invention. FIG. 8 is a cross-sectional view taken along the line VIII-VIII of FIG. 7.

Referring to FIGS. 7 and 8, the PDP 300 includes a first substrate 310, a second substrate 320, barrier ribs 330, first electrodes 360, the second electrodes 370, first phosphor layers 335, second phosphor layers 315, a dielectric layer 332, and protective layers 334. Compared with the PDP 200, the PDP 300 has the second electrodes 370 that are arranged on the second substrate 320 and that are buried in the dielectric layer 332. Therefore, the PDP 300 can generate a discharge of 90° between the first electrodes 360 and the second electrodes 370.

Since the PDP 300 generates the discharge of 90° between the first electrodes 360 and the second electrodes 370, the discharge generated in the PDP 300 is more similar to a discharge generated in an opposed discharge type PDP than that in the PDP 200. Therefore, the PDP 300 performs a more effective discharge than the PDP 200, thereby increasing brightness and luminous efficiency.

The first substrate 310 and the second substrate 320 are spaced apart from each other by a predetermined gap and face each other. The barrier ribs 330 are disposed between the first substrate 310 and the second substrate 320 and configure a plurality of discharge spaces 350. The first electrodes 360 are arranged in the first electrode layer 331 and extend in a direction between the first substrate 310 and the second substrate 320. The second electrodes 370 are arranged on the second substrate 320 and spaced apart from the first electrodes 360 by a predetermined gap.

The intermediate layer 333 is disposed between the first electrode layer 331 where the first electrodes 360 are arranged and the dielectric layer 332. In more detail, the barrier rib 330 includes the first electrode layer 331, the dielectric layer 332, and the intermediate layer 333 disposed between the first electrode layer 331 and the dielectric layer 332. Each of the first electrode layer 331 and the intermediate layer 333 can be formed of a sheet by a simple manufacturing process.

The first phosphor layers 335 are arranged on sidewalls of discharge spaces 350 contacting the intermediate layer 333. The first phosphor layers 335 can also be formed on the dielectric layer 332 which is disposed on the second substrate 320.

The diameter of each discharge space 350 contacting the intermediate layer 333 and the second substrate 320 is smaller than that contacting the first electrode layer 331. Therefore, the diameter of each discharge space 350 contacting the intermediate layer 33 is reduced from that of each discharge space 350 contacting the first electrode layer 331 to that of each discharge space 350 contacting the second substrate 320. Therefore, the diameter of each discharge space 350 contacting the second substrate 320 where the second electrodes 370 are arranged is reduced so as to form the an effective plasma column, whereas the diameter of each discharge space 350 contacting the first electrode layer 331 where the first electrodes 360 are arranged remains unchanged so as to correspond to the size of a pixel of an image displayed on the first substrate 310.

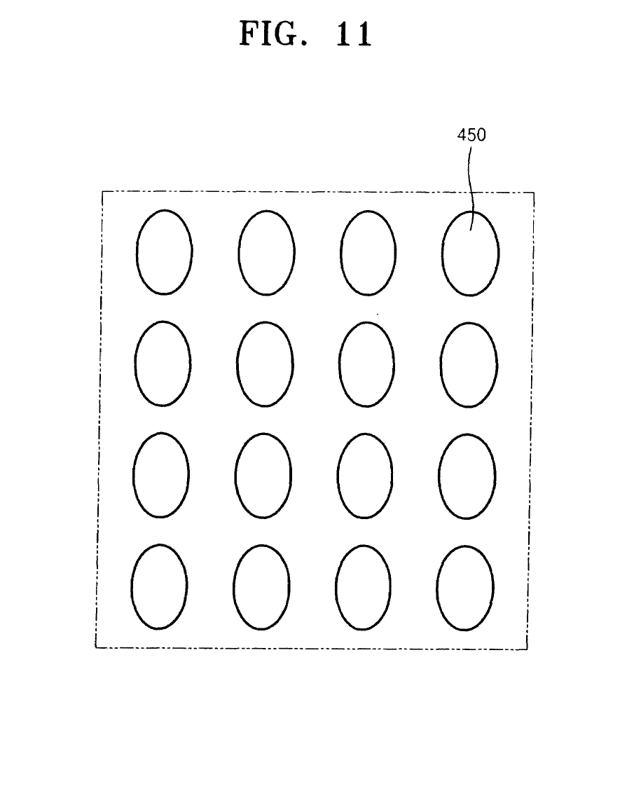

Also, the first phosphor layers 335′ may have a concave parabolic shape in a direction from the first electrode layer 331 to the dielectric layer 332 as shown in FIG. 10, and, accordingly, barrier rib 330′ would have a similarly shaped intermediate layer 333′.

In accordance with the present invention, phosphor layers are disposed between first and second electrodes which are spaced apart from each other in a direction in discharge spaces, and the sectional area of each discharge space contacting two regions where the first and second electrodes are respectively arranged has a different structure, so that the PDP can provide increased brightness.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel comprising:
a first substrate;
a second substrate spaced apart from and facing the first substrate;
barrier ribs between the first substrate and the second substrate, the barrier ribs configuring a plurality of discharge spaces;
first electrodes in the barrier ribs and extending in a first direction substantially parallel with the first substrate and the second substrate and between the first substrate and the second substrate;
second electrodes in the barrier ribs and spaced apart from the first electrodes, the second electrodes extending in a second direction;
an intermediate layer in the barrier ribs between the first electrodes and the second electrodes; and
a first phosphor layer on sidewalls of the discharge spaces at the intermediate layer.

2. The plasma display panel of claim 1, wherein a cross-sectional area of the discharge spaces decreases from the intermediate layer toward the second electrodes.

3. The plasma display panel of claim 1, wherein a cross-sectional area of the discharge spaces contacting the first phosphor layers is greater than a cross-sectional area of the discharge spaces proximal to the second electrodes.

4. The plasma display panel of claim 1, wherein the first phosphor layer is inclined linearly or in a concave parabolic shape in a direction from the first electrodes to the second electrodes.

5. The plasma display panel of claim 1, wherein the first phosphor layer is inclined at a predetermined angle and faces the first substrate.

6. The plasma display panel of claim 1, wherein the first electrodes and/or the second electrodes surround at least a portion of each of the discharge spaces.

7. The plasma display panel of claim 6, wherein a perimeter of the second electrodes surrounding the discharge spaces is shorter than a perimeter of the first electrodes.

8. The plasma display panel of claim 6, wherein a cross-sectional area of the discharge spaces surrounded by the second electrodes is smaller than a cross-sectional area of the discharge spaces surrounded by the first electrodes.

9. The plasma display panel of claim 1, wherein the first electrodes and the second electrodes extend to cross each other.

10. The plasma display panel of claim 1, wherein the first electrodes and the second electrodes extend in planes parallel to each other.

11. The plasma display panel of claim 1, wherein the discharge spaces have circular or oval cross-sections.

12. The plasma display panel of claim 1, further comprising: third electrodes spaced apart from the first electrodes and the second electrodes, which extend parallel to each other in the same direction and extend so as to cross the first electrodes and the second electrodes.

13. The plasma display panel of claim 1, further comprising:
a groove on the first substrate facing respective discharge spaces, the groove having a specific depth; and
a second phosphor layer arranged in the groove.

14. The plasma display panel of claim 1, wherein the first electrodes and/or the second electrodes are buried in the barrier ribs.

15. The plasma display panel of claim 1, wherein the barrier ribs comprise a first electrode layer housing the first electrodes, a second electrode layer housing the second electrodes, and an intermediate layer between the first electrode layer and the second electrode layer.

16. The plasma display panel of claim 15, wherein the first electrode layer is in a first electrode sheet, the second electrode layer is in a second electrode sheet, and the intermediate layer is an intermediate sheet between the first electrode sheet and the second electrode sheet.

17. The plasma display panel of claim 15, wherein the first electrode layer is in a first electrode sheet, and the second electrode layer and the intermediate layer are in a second sheet.

18. The plasma display panel of claim 15, further comprising:
a first protective layer within the discharge spaces contacting the first electrode layer; and
a second protective layer within the discharge spaces contacting the second electrode layer.

19. A plasma display panel comprising:
a first substrate;
a second substrate spaced apart from and facing the first substrate;
barrier ribs between the first substrate and the second substrate, the barrier ribs configuring a plurality of discharge spaces;
first electrodes in the barrier ribs and extending in a first direction substantially parallel with the first substrate and the second substrate between the first substrate and the second substrate;
second electrodes on the second substrate facing the first substrate, the second electrodes extending in a second direction substantially parallel with the first substrate and the second substrate between the first substrate and the second substrate and crossing the first electrodes;
an intermediate layer in the barrier ribs between the first electrodes and the second electrodes; and
a first phosphor layer on sidewalls of the discharge spaces at the intermediate layer,
wherein a cross-sectional area of the discharge spaces at the intermediate layer is larger than a cross-sectional area of the discharge spaces proximal to the second electrodes.

20. The plasma display panel of claim 19, further comprising: a dielectric layer on the second substrate burying the second electrodes, and
wherein the first phosphor layer is on sidewalls of the discharge spaces at the intermediate layer and on the dielectric layer in the discharge spaces.

21. The plasma display panel of claim 19, wherein a cross-sectional area of the discharge spaces contacting the first phosphor layers is greater than a cross-sectional area of the discharge spaces proximal to the second substrate

22. The plasma display panel of claim 19, wherein the first phosphor layer is inclined linearly or in a concave parabolic shape in a direction from the first electrodes to the second substrate.

23. The plasma display panel of claim 19, wherein the first electrodes surround at least a portion of each of the discharge spaces.

24. The plasma display panel of claim 19, wherein the discharge spaces have circular or oval cross-sections.

25. The plasma display panel of claim 19, further comprising:
a groove on the first substrate facing respective discharge spaces; and
a second phosphor layer in the groove.

26. The plasma display panel of claim 19, wherein the first electrodes are buried in the barrier ribs.

27. The plasma display panel of claim 19,
wherein the barrier ribs comprise a first electrode layer housing the first electrodes, and an intermediate layer between the first electrode layer and the second substrate, and
wherein the first electrode layer and the intermediate layer are formed of a sheet.

28. The plasma display panel of claim 27, further comprising:
a first protective layer within the discharge spaces contacting the first electrode layer.
